(19) United States
(12) Patent Application Publication
(10) Pub. No.: US 2007/0008923 A1
(43) Pub. Date: Jan. 11, 2007

(54) Method and system for allocating transmit power among a plurality of channels in a wireless communication system

(76) Inventors: Tarun K. Tandon, San Diego, CA (US); Insung Kang, San Diego, CA (US)

Correspondence Address: L. Howard Chen;PRESTON GATES & ELLIS LLP, Suite 1700, 55 Second Street, San Francisco, CA, 94102-3493, US

(21) Appl. No.: 11/178,039

(22) Filed: Jul. 8, 2005

(51) Int. Cl. H04B 1/04

(52) U.S. Cl. 370/329; 455/127.1

(57) ABSTRACT

A system for allocating transmit power among a plurality of channels in a wireless communication network includes a hub. The hub is for receiving reception quality information for the plurality of channels, and for adjusting the transmit power for the plurality of channels based on the reception quality information.

### FIELD OF THE INVENTION

The present invention relates to wireless communication systems in general, and more particularly to a system and method for allocating transmit power among a plurality of channels in a wireless communication system.

### BACKGROUND OF THE INVENTION

Present day communication systems such as cellular links often use some kind of resource sharing to support simultaneous connection of several users to a central hub having limited resources. Connections by multiple users are often identified as ‘channels.’ One of the goals of design of such communication systems is to maximize the number of channels, and therefore the number of users. One limit on the number of channels is available transmit power.

In a conventional one-to-many communication link being simultaneously shared by multiple channels, the available transmit power is divided equally among the channels. This is a fair power allocation scheme if all the channels have similar signal propagation conditions. In wireless communication systems, for example cell phones, this is not the case, resulting in unequal quality of reception for the users. Another problem is that the channel conditions typically vary over time.

Accordingly, what is needed is a system and method for allocating transmit power among a plurality of channels in a wireless communication system.

### BRIEF SUMMARY OF THE INVENTION

The present invention provides a system for allocating transmit power among a plurality of channels in a wireless communication network. The system comprises a hub for receiving reception quality information for the plurality of channels, and for adjusting the transmit power for the plurality of channels based on the reception quality information.

Because the system receives reception quality information, a determination is made about which channels may receive less transmit power without a perceptible loss in quality, and conversely which channels would benefit from an increase in transmit power. One embodiment of the present invention reduces the margin of the reception quality between the best channels and the worst channels.

### BRIEF DESCRIPTION OF SEVERAL VIEWS OF THE DRAWINGS

FIG. 1 is a block diagram illustrating one embodiment of a hub for allocating transmit power among a plurality of channels in a wireless communication system.

FIG. 2 is a flow diagram illustrating one method of allocating power among a plurality of channels.

### DETAILED DESCRIPTION OF THE INVENTION

The present invention relates to a method and system for allocating transmit power among a plurality of channels in a wireless communication system. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

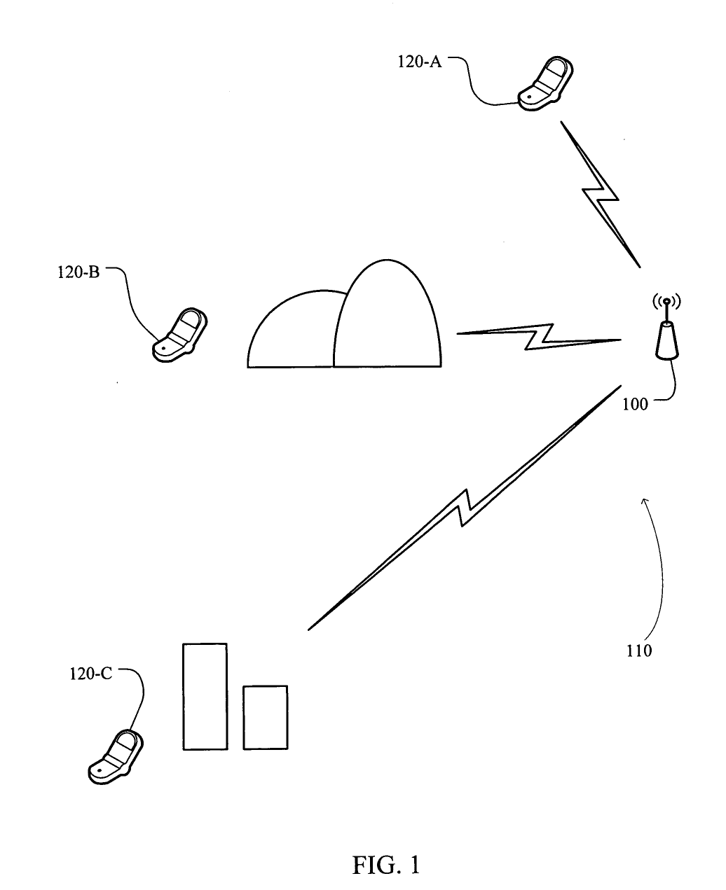

FIG. 1 is a block diagram illustrating one embodiment of a hub 100 for allocating transmit power among a plurality of channels in a wireless communication system 110. One of ordinary skill in the art will recognize that wireless communication system 110 may include many other components, for example base transceiver stations, base station controllers, mobile switching centers, and so on. In order to more specifically focus on the invention, the hub 100 will be representative of a transceiver and power allocation control center, although in another embodiment the hub 100 may be discrete components that are spatially separated. In another embodiment, the function of the hub 100 as described below occurs in a different component than the transmission and reception.

The hub 100 communicates with mobile stations (MS) 120-A, 120-B and 120-C (collectively referred to as MS 120) using any form of wireless communication that provides a feedback channel in the link between a given MS 120 and the hub 100. Although three MS 120 are illustrated, the hub 100 may communicate with more or fewer than that.

The hub 100 may have a short, line-of-sight connection to the MS 120-A. The connection to the MS 120-B may be further away than that for MS 120-A and may have hills in between the hub 100 and the MS 120-B. The MS 120-C may be the furthest away and surrounded by buildings.

Each of the MS 120 determines reception quality, indicative of the channel conditions at that time. One example of reception quality is determined by Carrier-to-Interference Ratio (C/I) measurements, which may be coded. Another example is the signal-to-noise ratio, or SNR. Other examples include RSSI, packet error rate, or data rate channel (DRC).

Each MS 120 has a connection to the hub 100 over a channel. The reception quality information may be sent along a feedback portion of the channel between each MS 120 and the hub 100. The reception quality information received by the hub 100 may be updated periodically or as conditions changes. One factor affecting reception quality is location, therefore a MS in a vehicle likely has greater variability in reception quality compared to a stationary MS.

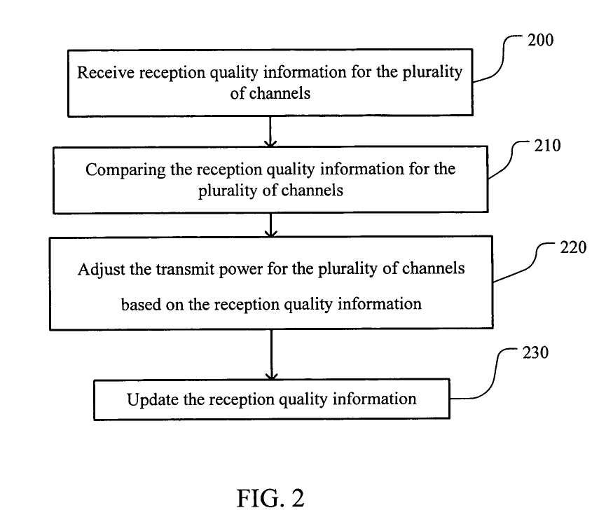

FIG. 2 is a flow diagram illustrating one method of allocating power among a plurality of channels in system 110. FIG. 2 will be discussed in conjunction with FIG. 1. In block 200, the hub 100 receives reception quality information for the plurality of channels, from each of MS 120. In one embodiment, the reception quality information is in the form of C/I measurements.

In block 210, the hub 100 compares the reception quality information for the plurality of channels. This may be a direct comparison or an evaluation of relative strength. In one embodiment, the following expression may be used to evaluate the transmit power for each of the MS 120:
(Tp)ᵢ=(C/I)ᵢ⁻¹/Σᵢ (C/I)⁻¹
where (Tp)ᵢ is the transmit power for the i-th channel, while (C/I)ᵢ is the estimated Carrier-to-Interference Ratio for the i-th channel as reported through each feedback portion of the i-th channel. The above formula is solved by first taking a summation of the inverse of the C/I over all channels. With this summation, an amount of transmit power to devote to a particular channel is determined by dividing the inverse of the C/I for the particular channel by the summation. The result will yield a fraction, indicating the fraction of the total transmit power available that should be allocated to the particular i-th channel.

After determining the amount of transmit power to devote to each channel, in block 220 the hub 100 adjusts the transmit power for each of the plurality of channels based on the reception quality information. Returning to FIG. 1, the MS 120-A likely had the best C/I, and therefore after block 220 receives the least amount of the available transmit power. The MS 120-B conveyed worse reception quality information than the MS 120-A dues to the hills, so receives proportionately more transmit power from hub 100. The MS 120-C conveys the worst reception quality information of the three, so receives the most transmit power from the hub 100.

In block 230, the hub 100 updates the reception quality information from the MS 120. The updates may be periodic, they may be requested by the hub 100, or they may be sent as reception quality changes.

One advantage of the invention is a more fair allocation of available transmit power among multiple channels. Another advantage is that a minimum reception quality can be determined, and based upon that minimum quality the number of channels available can be maximized, improving network capacity.

According to the method and system disclosed herein, the present invention provides a system and method for allocating transmit power among a plurality of channels in a wireless communication system. One skilled in the art will recognize that many other logic combinations are possible, with all the signals reversed or even other combination applied. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for allocating transmit power among a plurality of channels in a wireless communication system comprising:
receiving reception quality information for the plurality of channels; and
adjusting the transmit power for the plurality of channels based on the reception quality information.

2. The method of claim 1 further comprising:
comparing the reception quality information for the plurality of channels.

3. The method of claim 2 further comprising:
equalizing the quality of reception for the plurality of channels.

4. The method of claim 3, equalizing the quality of reception further comprising:
adjusting the transmit power for a particular one of the plurality of channels based on the quality of reception for the particular one of the plurality of channels in relation to the quality of reception of the plurality of channels

5. The method of claim 4, receiving information further comprising:
gathering reception quality information for the plurality of users through a plurality of feedback channels.

6. The method of claim 4 further comprising:
updating the reception quality information.

7. A method for allocating transmit power among a plurality of channels in a wireless communication system comprising:
receiving a carrier-to-interference ratio for each of the plurality of channels;
adding together, into a summation, an inverse of the carrier-to-interference ratio for all the plurality of channels; and
calculating a transmit power for a particular one of the plurality of channels by dividing the inverse of the carrier-to-interference ratio for the particular one of the plurality of channels by the summation.

8. A system for allocating transmit power among a plurality of channels in a wireless communication network comprising:
a hub for receiving reception quality information for the plurality of channels, and for adjusting the transmit power for the plurality of channels based on the reception quality information.

9. The system of claim 8, the hub further for comparing the reception quality information for the plurality of channels.

10. The system of claim 9, the hub further for equalizing the quality of reception for the plurality of channels.

11. The system of claim 10, the hub further for adjusting the transmit power for a particular one of the plurality of channels based on the quality of reception for the particular one of the plurality of channels in relation to the quality of reception of the plurality of channels

12. The system of claim 11, the hub further for gathering reception quality information for the plurality of users through a plurality of feedback channels.

13. The system of claim 11, the hub further for updating the reception quality information.

14. The system of claim 8, the hub further for receiving a carrier-to-interference ratio for each of the plurality of channels, adding together, into a summation, an inverse of the carrier-to-interference ratio for all the plurality of channels, and calculating a transmit power for a particular one of the plurality of channels by dividing the inverse of the carrier-to-interference ratio for the particular one of the plurality of channels by the summation.
